(19) United States
(12) Patent Application Publication
(10) Pub. No.: US 2022/0140648 A1
(43) Pub. Date: May 5, 2022

(54) METHODS, SYSTEMS, AND COMPUTER PROGRAM PRODUCTS FOR ADAPTIVE WIDE-AREA DAMPING CONTROL USING A TRANSFER FUNCTION MODEL DERIVED FROM MEASUREMENTS

(71) Applicant: University of Tennessee Research Foundation, Knoxville, TN (US)

(72) Inventors: Ibrahim Abdullah S. ALTARJAMI, Knoxville, TN (US); Evangelos FARANTATOS, Encino, CA (US); Hossein HOOSHYAR, White Plains, NY (US); Yilu LIU, Knoxville, TN (US); Mahendra PATEL, Phoenixville, PA (US); Huangqing XIAO, Knoxville, TN (US); Chengwen ZHANG, Knoxville, TN (US); Yi ZHAO, Knoxville, TN (US); Lin ZHU, Knoxville, TN (US)

(21) Appl. No.: 17/085,703

(22) Filed: Oct. 30, 2020

(51) Int. Cl. H02J 13/00

(52) U.S. Cl. CPC H02J 13/00026; H02J 13/0001; H02J 13/00016

(57) ABSTRACT

A method includes injecting a probe signal into a power system; receiving a measurement of an operational parameter of the power system responsive to injecting the probe signal into the power system; generating a transfer function model of the power system based on the measurement of the operational parameter of the power system and the probe signal; and updating at least one control parameter of a Wide Area Damping Controller (WADC) communicatively coupled to the power system based on the transfer function model.

### STATEMENT REGARDING FEDERALLY SPONSORED RESEARCH OR DEVELOPMENT

This invention was made with government support under contract number NSF EEC-104187 awarded by the National Science Foundation. The government has certain rights in the invention.

### BACKGROUND

The present disclosure relates to power systems, and, in particular, to damping low frequency inter-area oscillations in power systems.

Inter-area oscillations may result in a power system when large power generation and load complexes are separated by long distance transmission lines. In a large power system, these oscillations are typically between 0.2 and 1.0 Hz and may persist for extended periods due to low damping. These low frequency oscillations can lead to a system breakup if the damping is too low. The power flow on some transmission lines may be limited to preserve small signal stability. Improving small signal stability may higher power flow.

Wide-area damping control is a class of automatic control systems used to provide stability augmentation to power systems, by, for example, damping low frequency inter-area oscillations. A Wide Area Damping Controller (WADC) with fixed control parameters may not provide sufficient damping control under varying power system operating conditions. WADC design is typically based on a power system planning model, which may not take into account variations in operation of the power system.

### SUMMARY

In some embodiments of the inventive concept, a method comprises injecting a probe signal into a power system; receiving a measurement of an operational parameter of the power system responsive to injecting the probe signal into the power system; generating a transfer function model of the power system based on the measurement of the operational parameter of the power system and the probe signal; and updating at least one control parameter of a Wide Area Damping Controller (WADC) communicatively coupled to the power system based on the transfer function model.

In other embodiments, the operational parameter of the power system is a frequency of a power system signal, a voltage magnitude of the power system signal, or a voltage angle of the power system signal.

In still other embodiments, the probe signal has a magnitude whose value over time is represented by a Hann function.

In still other embodiments, injecting the probe signal into the power system comprises injecting the probe signal at a voltage set point of a generator, at a voltage set point of a Flexible Alternating Current Transmission System (FACTS) device, or at an active power set point of a High Voltage Direct Current (HVDC) link.

In still other embodiments, injecting the probe signal into the power system comprises repeating injection of the probe signal into the power system. Receiving the measurement of the operational parameter of the power system responsive to injecting the probe signal into the power system comprises receiving multiple measurements of the operational parameter of the power system responsive to repeating injection of the probe signal into the power system. The method further comprises averaging the multiple measurements of the operational parameter to generate an average measurement of the operational parameter.

In still other embodiments, generating the transfer function model of the power system based on the measurement of the operational parameter of the power system and the probe signal comprises generating the transfer function model of the power system based on the average measurement of the operational parameter of the power system and the probe signal.

In still other embodiments, the method further comprises associating the multiple measurements of the operational parameter of the power system with the repeated injections of the probe signal, respectively, with respect to time.

In still other embodiments, the method further comprises storing the multiple measurements of the operational parameter of the power system in a buffer so as to be sorted by delay; selecting ones of the multiple measurements of the operational parameter of the power system that are closest to a defined delay value; and using the selected ones of the multiple measurements to generate a control command for damping low-frequency oscillations of the power system.

In still other embodiments, updating the at least one control parameter of the WADC comprises updating a time constant, a control gain, or a filter transfer function used in the WADC.

In still other embodiments, the WADC comprises a control structure module and a delay compensator module, each of the control structure module and the delay compensator module having at least one time constant and a control gain associated therewith. Updating the at least one control parameter of the WADC comprises updating the at least one time constant or the control gain in each of the control structure module and the delay compensator module.

In still other embodiments, the WADC comprises a combined control structure module and delay compensator module having at least one combined time constant and a combined control gain associated therewith. Updating the at least one control parameter of the WADC comprises updating the at least one combined time constant or the combined control gain of the combined control structure module and delay compensator module.

In some embodiments of the inventive concept, a system comprises a processor and a memory coupled to the processor and comprising computer readable program code embodied in the memory that is executable by the processor to perform operations comprising: injecting a probe signal into a power system; receiving a measurement of an operational parameter of the power system responsive to injecting the probe signal into the power system; generating a transfer function model of the power system based on the measurement of the operational parameter of the power system and the probe signal; and updating at least one control parameter of a Wide Area Damping Controller (WADC) communicatively coupled to the power system based on the transfer function model.

In further embodiments, the operational parameter of the power system is a frequency of a power system signal, a voltage magnitude of the power system signal, or a voltage angle of the power system signal.

In still further embodiments, injecting the probe signal into the power system comprises repeating injection of the probe signal into the power system. Receiving the measurement of the operational parameter of the power system responsive to injecting the probe signal into the power system comprises receiving multiple measurements of the operational parameter of the power system responsive to repeating injection of the probe signal into the power system. The operations further comprise averaging the multiple measurements of the operational parameter to generate an average measurement of the operational parameter.

In still further embodiments, updating the at least one control parameter of the WADC comprises updating a time constant, a control gain, or a filter transfer function used in the WADC.

In still further embodiments, the WADC comprises a control structure module and a delay compensator module, each of the control structure module and the delay compensator module having at least one time constant and a control gain associated therewith. Updating the at least one control parameter of the WADC comprises updating the at least one time constant or the control gain in each of the control structure module and the delay compensator module.

In still further embodiments, the WADC comprises a combined control structure module and delay compensator module having at least one combined time constant and a combined control gain associated therewith. Updating the at least one control parameter of the WADC comprises updating the at least one combined time constant or the combined control gain of the combined control structure module and delay compensator module.

In some embodiments of the inventive concept, a computer program product comprises a non-transitory computer readable storage medium comprising computer readable program code embodied in the medium that is executable by a processor to perform operations comprising: injecting a probe signal into a power system; receiving a measurement of an operational parameter of the power system responsive to injecting the probe signal into the power system; generating a transfer function model of the power system based on the measurement of the operational parameter of the power system and the probe signal; and updating at least one control parameter of a Wide Area Damping Controller (WADC) communicatively coupled to the power system based on the transfer function model.

In other embodiments, the operational parameter of the power system is a frequency of a power system signal, a voltage magnitude of the power system signal, or a voltage angle of the power system signal.

In still other embodiments, updating the at least one control parameter of the WADC comprises updating a time constant, a control gain, or a filter transfer function used in the WADC.

Other methods, systems, articles of manufacture, and/or computer program products according to embodiments of the inventive subject matter will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a power distribution network including adaptive wide-area damping control in accordance with some embodiments of the inventive concept;

FIG. 2 is a block diagram of the adaptive Wide Area Damping Controller (WADC) of FIG. 1 in accordance with some embodiments of the inventive concept;

FIGS. 3 and 4 are block diagrams of the adaptive WADC and power system of FIGS. 1 and 2 illustrating damping control and transfer function model derivation, respectively, in accordance with some embodiments of the inventive concept;

FIGS. 5-7 are flowcharts that illustrate operations for updating parameters of the adaptive WADC based on a transfer function model derived from power system operational parameter measurements in accordance with some embodiments of the inventive concept;

FIG. 8 is a graph of probe signals used in deriving the transfer function model of the power system in accordance with some embodiments of the inventive concept;

FIG. 9 is graph of that illustrates averaging of power system operational parameter measurements for use in deriving the transfer function model in accordance with some embodiments of the inventive concept;

FIGS. 10A and 10B are conceptual diagrams that illustrate alignment of power system operational parameter measurements with probe signals with respect to time in accordance with some embodiments of the inventive concept;

FIG. 11 is a block diagram of a buffering methodology for the power system operational parameter measurements in accordance with some embodiments of the inventive concept;

FIG. 12 is a block diagram that illustrates a combined reversed compensation WADC control structure according to some embodiments of the inventive concept;

FIG. 13 is a graph that illustrates damping of low frequency inter-area oscillations using the adaptive WADC with standard compensation and combined reversed compensation in accordance with some embodiments of the inventive concept;

FIG. 14 is a graph that illustrates damping of low frequency inter-area oscillations with a non-adaptive WADC and with an adaptive WADC in accordance with some embodiments of the inventive concept compared with no damping;

FIGS. 15A and 15B are graphs that illustrate separation of a power system without damping and preservation of the power system with damping provided by an adaptive WADC in accordance with some embodiments of the inventive concept; and

FIG. 16 is a simplified block diagram of a controller used in the adaptive WADC of FIG. 1 in accordance with some embodiments of the inventive concept.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term a data processing system may include, but it is not limited to, a hardware element, firmware component, and/or software component.

Some embodiments of the inventive concept stem from a realization that Wide Area Damping Controllers (WADC), which are used to provide damping of low frequency inter-area oscillations in power systems, are typically designed based on a system planning model, which may be very large, e.g., tens of thousands of buses, and often not very accurate. The planning model may be updated infrequently; therefore, dynamic control by responding to frequent changes in the operating conditions of the power system may not be provided. Some embodiments of the inventive concept may provide an adaptive WADC in which a low order transfer function model of the power system oscillatory behavior may be generated based on measurements of power system operational parameters. This transfer function model may then be used to update one or more control parameters of the WADC. An adaptive WADC, according to some embodiments of the inventive concept, may provide a less complex, lower order model of the power system behavior with relatively high accuracy. Moreover, the transfer function model can be updated many times an hour allowing the WADC control parameter(s) to be updated frequently to provide improved damping of the low frequency inter-area oscillations.

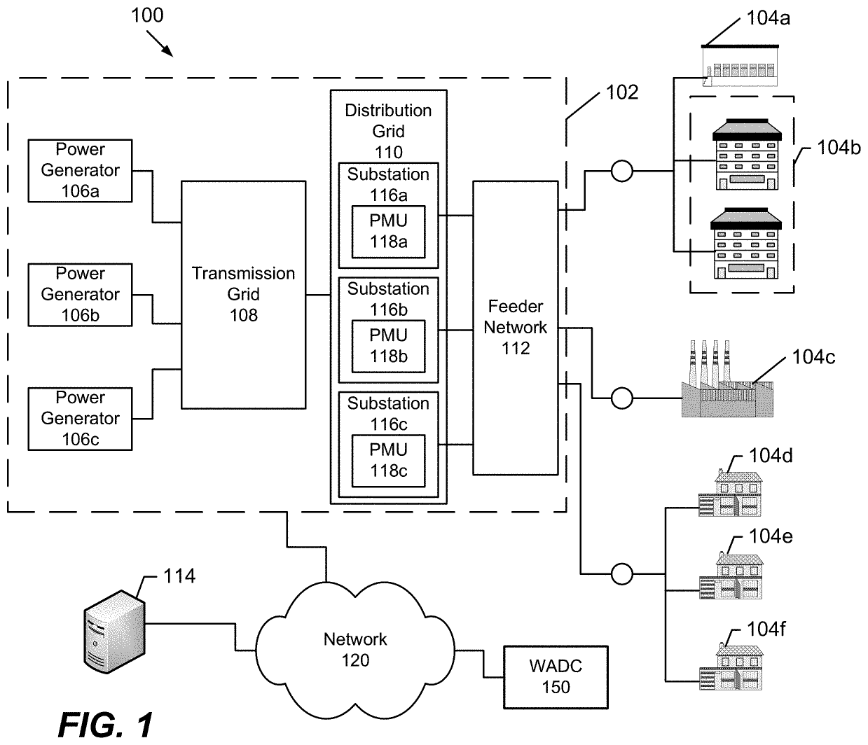

Referring to FIG. 1, a power system distribution network 100 including an adaptive wide-area damping control capability, in accordance with some embodiments of the inventive concept, comprises a main power grid 102, which is typically operated by a public or private utility, and which provides power to various power consumers 104a, 104b, 104c, 104d, 104e, and 104f. The electrical power generators 106a, 106b, and 106c are typically located near a fuel source, at a dam site, and/or at a site often remote from heavily populated areas. The power generators 106a, 106b, and 106c may be nuclear reactors, coal burning plants, hydroelectric plants, and/or other suitable facility for generating bulk electrical power. The power output from the power generators 106, 106b, and 106c is carried via a transmission grid or transmission network over potentially long distances at relatively high voltage levels. A distribution grid 110 may comprise multiple substations 116a, 116b, 116c, which receive the power from the transmission grid 108 and step the power down to a lower voltage level for further distribution. A feeder network 112 distributes the power from the distribution grid 110 substations 116a, 116b, 116c to the power consumers 104a, 104b, 104c, 104d, 104e, and 104f. The power substations 116a, 116b, 116c in the distribution grid 110 may step down the voltage level when providing the power to the power consumers 104a, 104b, 104c, 104d, 104e, and 104f through the feeder network 112.

As shown in FIG. 1, the power consumers 104a, 104b, 104c, 104d, 104e, and 104f may include a variety of types of facilities including, but not limited to, a warehouse 104a, a multi-building office complex 104b, a factory 104c, and residential homes 104d, 104e, and 104f. A feeder circuit may connect a single facility to the main power grid 102 as in the case of the factory 104c or multiple facilities to the main power grid 102 as in the case of the warehouse 104a and office complex 104b and also residential homes 104d, 104e, and 104f. Although only six power consumers are shown in FIG. 1, it will be understood that a feeder network 112 may service hundreds or thousands of power consumers.

The power distribution network 100 further comprises a Distribution Management System (DMS) 114, which may monitor and control the generation and distribution of power via the main power grid 102. The DMS 114 may comprise a collection of processors and/or servers operating in various portions of the main power grid 102 to enable operating personnel to monitor and control the main power grid 102. The DMS 114 may further include other monitoring and/or management systems for use in supervising the main power grid 102. One such system is known as the Supervisory Control and Data Acquisition (SCADA) system, which is a control system architecture that uses computers, networked data communications, and graphical user interfaces for high-level process supervisory management of the main power grid. The DMS 114 may further include a phasor data concentrator module that is configured to manage the reception and processing of synchrophasor measurements from the PMUs 118a, 118b, and 118c. The phasor data concentrator module may cooperate with other supervisory, monitoring, and control modules, systems, and/or capabilities provided via the DMS 114.

According to some embodiments of the inventive concept, PMUs 118a, 118b, and 118c may be located at the substations 116a, 116b, and 116c, respectively. PMUs measure current and voltage by amplitude and phase at selected stations of the distribution grid 110. Using Global Positioning System (GPS) information, for example, high-precision time synchronization may allow comparing measured values (synchrophasors) from different substations distant to each other and drawing conclusions regarding the system state and dynamic events, such as power swing conditions. The PMUs 118a, 118b, 118c may determine current and voltage phasors, frequency, and rate of change of frequency and provide these measurements with time stamps for transmittal to the DMS 114 for analysis. The PMUs 118a, 118b, 118c may communicate with the DMS 114 over the network 120. The network 120 may be a global network, such as the Internet or other publicly accessible network.

As shown in FIG. 1, the power system distribution network 100 further includes an adaptive WADC 150 in accordance with some embodiments of the inventive concept. The adaptive WADC 150 may be configured to provide damping for low frequency inter-area oscillations using control parameters that are adapted to a current operational state of the power system 100. In some embodiments, a transfer function model of the power system 100 may be generated using the power system operational parameter measurements obtained from the PMUs 118a, 118b, 118c. The transfer function model may then be used as a basis for updating one or more control parameters of the adaptive WADC 150. In accordance with various embodiments of the inventive concept, the adaptive WADC 150 may be configured to receive measurements from the PMUs 118a, 118b, and 118c or may receive these measurements by way of the DMS 114. Moreover, generation of the transfer function model of the power system may be performed in the adaptive WADC 150 or performed in the DMS 114 or other data processing system and communicated to the adaptive WADC 150 in accordance with different embodiments of the inventive concept. The adaptive WADC 150 may also be communicatively coupled to the power system distribution network 100 by way of the network 120 or other suitable connection.

Various elements of the network 120 may be interconnected by a wide area network, a local area network, an Intranet, and/or other private network, which may not be accessible by the general public. Thus, the communication network 120 may represent a combination of public and private networks or a virtual private network (VPN). The network 120 may be a wireless network, a wireline network, or may be a combination of both wireless and wireline networks. Although the PMUs 118a, 118b, and 118c are shown as being located in the substations 116a, 116b, and 116c, it will be understood that the PMUs may be located in other locations within the distribution grid 110, within the main power grid 102, or even at consumer locations 104a, 104b, 104c, 104d, 104e, and 104f, such as, for example, in proximity to wall outlets or other power access points.

Although FIG. 1 illustrates an example a power distribution network 100 including an adaptive wide-area damping control capability, it will be understood that embodiments of the inventive concept are not limited to such configurations, but are intended to encompass any configuration capable of carrying out the operations described herein.

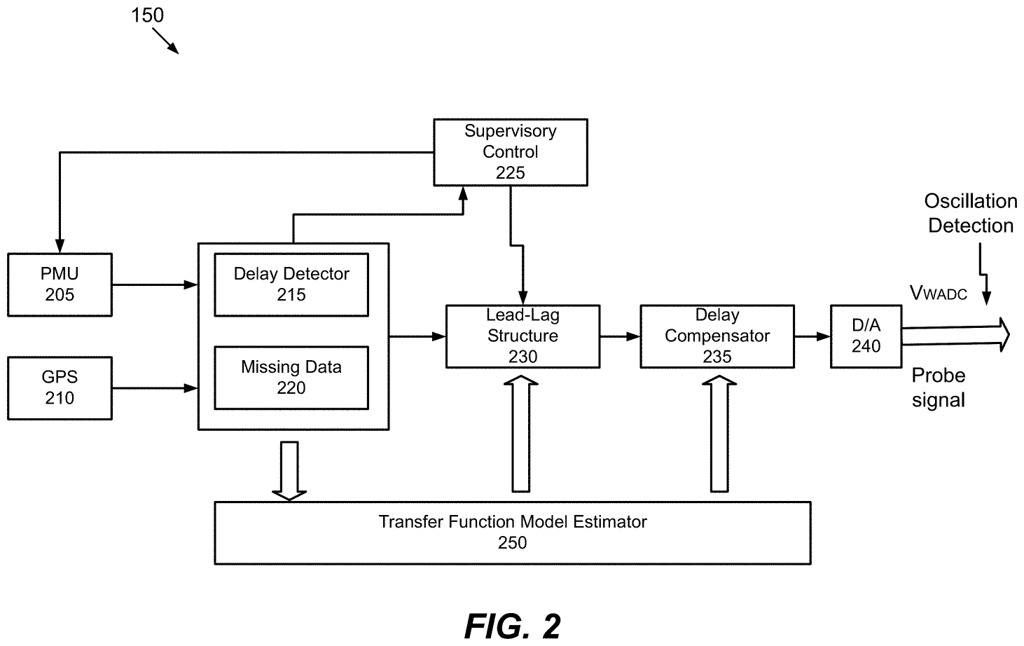

FIG. 2 is a block diagram of the adaptive WADC 150 of FIG. 1 in accordance with some embodiments of the inventive concept. As shown in FIG. 2, the adaptive WADC 150 includes a PMU module 205, GPS module 210, delay detector module 215, missing data module 220, supervisory control module 225, lead-lag structure module 230, delay compensator module 235, digital-to-analog converter module 240, and a transfer function model estimator module 250 that are configured as shown. The PMU 205 module may be configured to receive measurements of one or more operational parameters of the power system 100 from the PMUs 118a, 118b, and 118c. The GPS module 210 may be used to timestamp the PMU measurement data received via the PMU module 205. The delay detector 215 may be configured to measure the delay of the received PMU measurement data and to align the data with, for example, probe signals used to generate the transfer function model of the power system 100. As there may be occasional data loss, the missing data module 220 may be configured to compensate for missing PMU measurement data. The supervisory control module 225 may be configured to select between primary PMUs 118a, 118b, and 118c used for collecting operational parameter measurements from the power system 100 and backup PMUs 118a, 118b, and 118c. The lead-lag structure module 230 and the delay compensator module 230 may provide the control functionality of the adaptive WADC 150 for damping low frequency inter-area oscillations. The lead-lag structure module 230 may be configured to generate the control command and the delay compensator 235 module may be configured to reduce or eliminate the impact of constant and/or random delay. The digital-to-analog converter module 240 may be configured to convert the digital signal output from the delay compensator 235 to an analog control output. As shown in FIG. 2, when the WADC 150 is operating in a damping mode to reduce log frequency inter-area oscillation, a control command V_{WADC} is generated, which can be supplied to the power system 100 when oscillation is detected.

As described above, the WADC 150 may adapt to a current operational state of the power system 100 by generating a transfer function model of the power system 100 and using the transfer function model to update the control parameters of the WADC 150, e.g., the parameters of the lead-lag structure module 230 and/or the delay compensator module 235. The transfer function model estimator module 250 may be configured to inject probe signals into the power system 100 as stimulus and collect measurements of one or more operational parameters of the power system 100 in response through the PMU data. Upon generating the transfer function model of the power system 100 based on the measurements of one or more operational parameters of the power system 100 and the probe signal, the transfer function model estimator module 250 may then update one or more control parameters of the lead-lag structure module 230 and/or the delay compensator module 235.

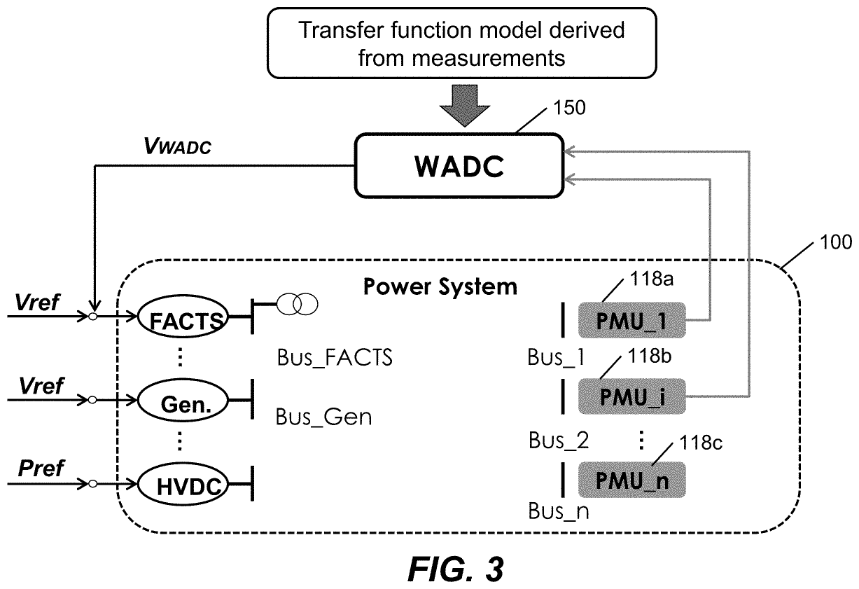

FIGS. 3 and 4 are block diagrams of the adaptive WADC 150 and power system 100 of FIGS. 1 and 2 illustrating damping control and transfer function model derivation, respectively, in accordance with some embodiments of the inventive concept. Referring to FIG. 3, the adaptive WADC 150 may be configured to provide damping for low frequency inter-area oscillations in the power system 100 by receiving operational parameter measurements of the power system from the PMUs 118a, 118b, and 118c and generating a control command V_{WADC}. The adaptive WADC 150 may be configured with a transfer function model of the power system 100 derived in accordance with embodiments described herein. The control command V_{WADC} may be provided to the power system 100 at various locations including a voltage set point of a generator, a voltage set point of a Flexible Alternating Current Transmission System (FACTS) device, or at an active power set point of a High Voltage Direct Current (HVDC) link.

Referring to FIG. 4, the adaptive WADC 150 may be configured to generate a transfer function model of the power system 100 and to use the transfer function model to update the control parameters of the WADC 150. The transfer function model estimator module 250 may be configured to inject probe signals into the power system 100 as stimulus. In some embodiments, the probe signal may be a Hann signal, i.e., a signal that has a magnitude whose value over time is represented as a Hann function. The probe signal, e.g., Hann signal, may be provided to the power system 100 at various locations including a voltage set point of a generator, a voltage set point of a FACTS device, or at an active power set point of a HVDC link. The power system 100 response to the Hann signal is received at the adaptive WADC 150 in the form of data from the PMUs 118a, 118b, and 118c including measurements of one or more operational parameters of the power system 100. The transfer function model estimator module 250 of the adaptive WADC 150 may generate the transfer function model of the power system 100 based on the measurements of one or more operational parameters of the power system 100 and the probe signal, e.g., Hann signal. The transfer function model estimator module 250 may then update one or more control parameters of the adaptive WADC 150.

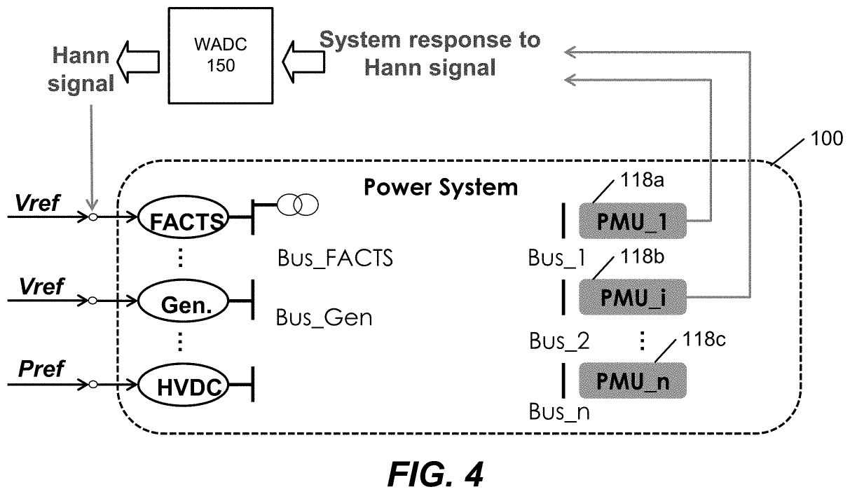

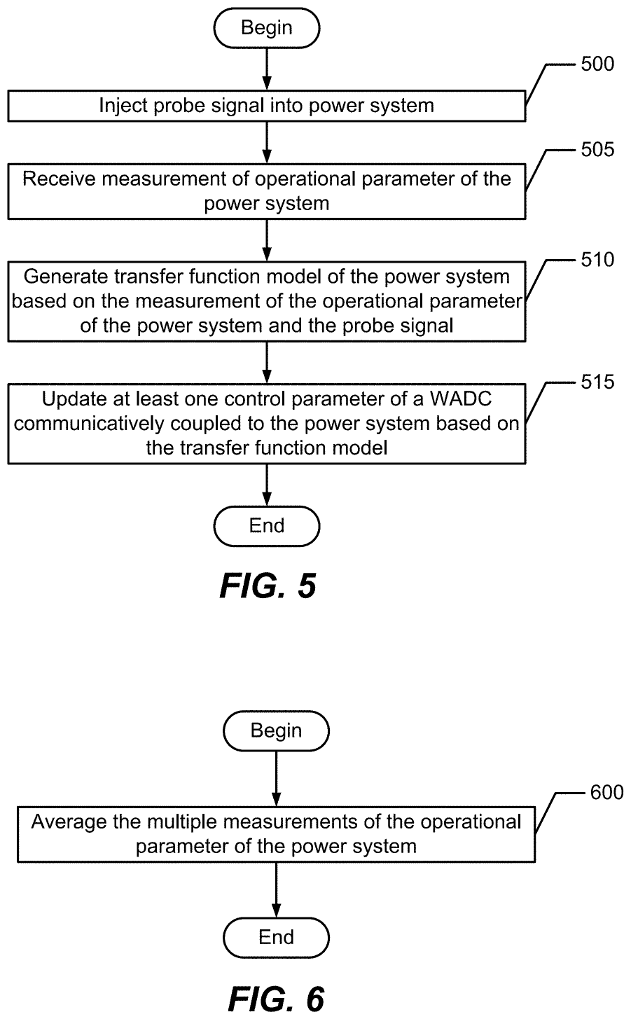

FIGS. 5-7 are flowcharts that illustrate operations for updating parameters of the adaptive WADC 150 based on a transfer function model derived from power system operational parameter measurements in accordance with some embodiments of the inventive concept. Referring now to FIG. 5, operations begin at block 500 where the transfer function model estimator module 250 injects a probe signal, such as a Hann signal, into the power system 100 at, for example, a voltage set point of a generator, a voltage set point of a FACTS device, or at an active power set point of a HVDC link. FIG. 8 illustrates two examples of a Hann signal: a two second duration signal and a one second duration signal. The spectrum of the Hann signal is generally evenly concentrated at the frequency band of the inter-area low frequency modes, e.g., 0 Hz-2 Hz. In some embodiments, the power system 100 response to the probe signal is slightly above the system ambient noise so as to reduce the impact on the operation of the power system.

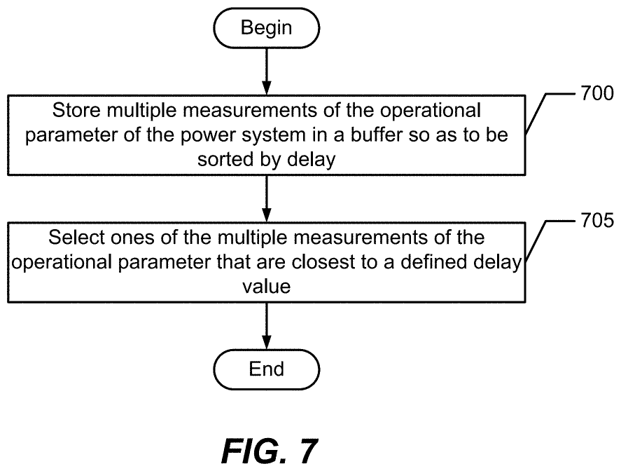

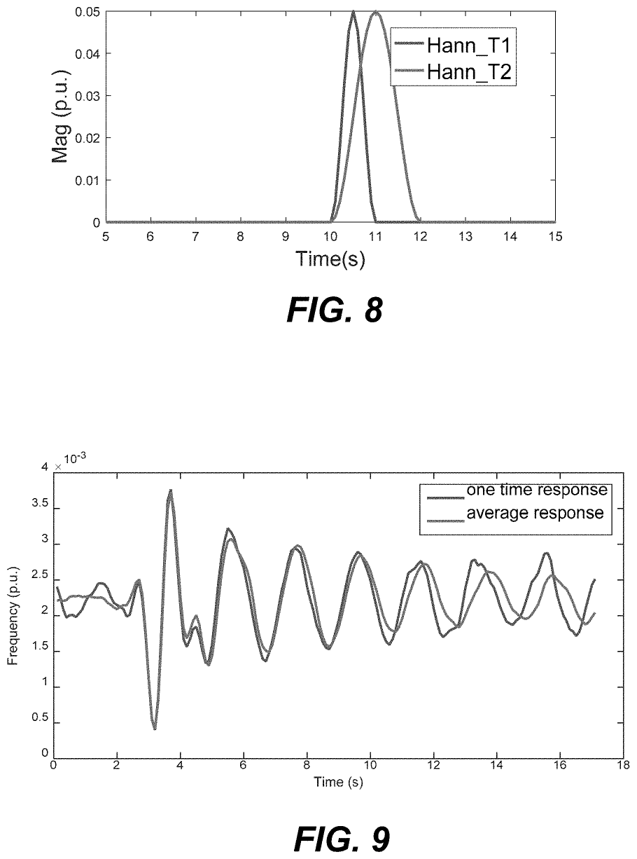

At block 505, the measurements of one or more operational parameters of the power system 100 are received from the PMUs 118a, 118b, and 118c in response to the one or more probe signals. The power system 100 operational parameters may include, but are not limited to, frequency of a power system signal, voltage magnitude of the power system signal, and voltage angle of the power system signal. In some embodiments of the inventive concept, the probe signal may be injected numerous times (e.g., 5 or more times) to reduce the effects of environmental and/or measurement noise. Referring now to FIGS. 10A and 10b, the delay detector module 215 may align the power system operational parameter measurement data from the PMUs 118a, 118b, and 118c with the probe signals with respect to time. As shown in FIG. 10A, the PMU data (ovals) are delayed in time with respect to the probe signals (blocks). As shown in FIG. 10B, the PMU data (ovals) are aligned in time with the probe signals (blocks) so each measurement can be associated with the probe signals that served as its stimulus. Referring now to FIG. 6, to reduce the effects of environmental or measurement noise, the measurements of the one or more operational parameters of the power system 100 may be averaged at block 600. As shown in FIG. 9, by averaging the power system operational parameter measurements over multiple probe signal injection cycles, the signal-to-noise ratio can be improved.

Returning to FIG. 5, at block 510, the transfer function model estimator 250 may generate a transfer function model of the power system 100 based on the measurements of one or more operational parameters of the power system 100 and the probe signal(s). In some embodiments, the transfer function model may be a linear, low order transfer function model and the transfer function model estimator 250 may estimate an order of the transfer function model of the power system 100 and may also estimate the coefficients of the transfer function model of the power system 100. At block 515, the transfer function model estimator 250 may update one or more control parameters of the adaptive WADC 150, such as parameters used for control in the lead-lag structure module 230 and/or parameters used for constant and random time delay compensation in the delay compensator module 235. The adaptive WADC 150 control parameters may include, but are not limited to, a time constant, a control again, and/or a filter transfer function.

The operations of FIG. 5 may be periodically repeated (e.g., every 15 minutes) to track operating conditions of the power system 100 so as to provide adaptability to the WADC 150. Thus, the adaptive WADC 150 may generate a new set of control parameters periodically at a desired rate to match typical operating condition changes in the power system 100 for which the adaptive WADC 150 is used for low frequency inter-area oscillation damping.

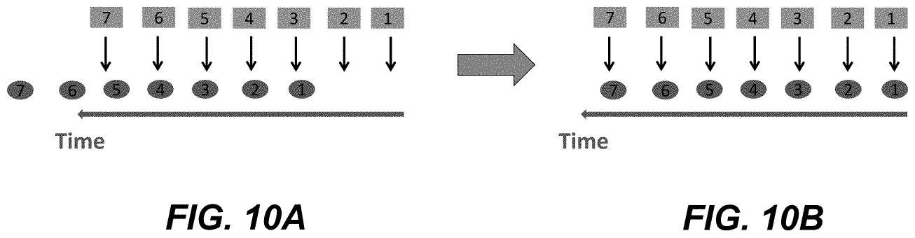

Referring now to FIGS. 7 and FIG. 11, when PMU 118a, 118b, and 118c measurements are received at the adaptive WADC 150, they may be stored in a buffer and sorted according to delay at block 700. When generating control commands (V_{WADC}) and/or when generating a transfer function model of the power system 110, the adaptive WADC 150 may select those PMU measurements of one or more operational parameters of the power system 110 that have a pre-defined delay value at block 705. When all the PMU measurements used to generate control commands have similar delays, the adaptive WADC may reduce the frequency of switching among different compensation parameter sets.

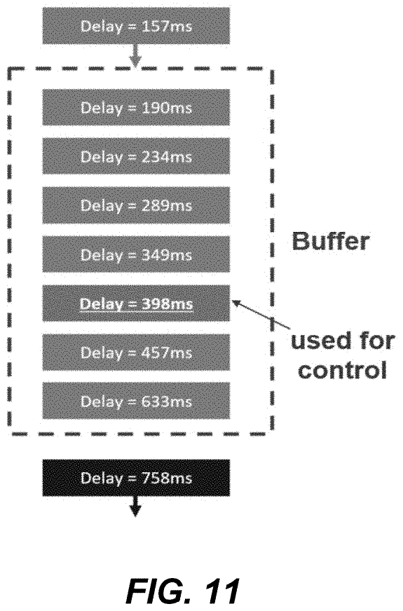

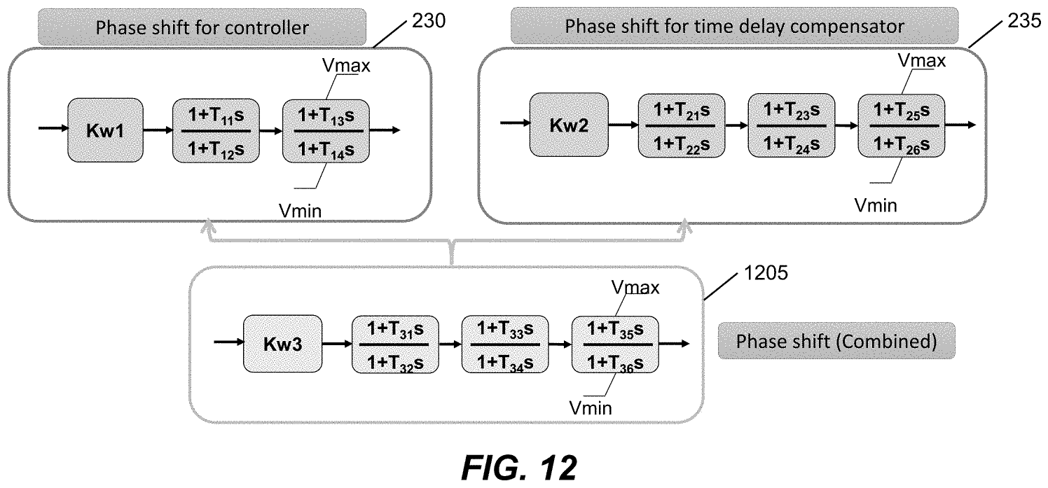

FIG. 12 is a block diagram that illustrates a combined reversed compensation WADC control structure according to some embodiments of the inventive concept. As shown in FIGS. 2 and 12, the lead-lag structure module 230 and the delay compensator structure module 235 may be configured as separate modules with separate gain (K) and time constant (Tₓ) control parameters. In some embodiments, the phase shift for the control command generated by the lead-lag structure module 230 may be combined with the phase shift for time delay compensation generated by the delay compensator module 235 to generate a combined control structure and delay compensation module 1205. The compensation provided by the combined control structure and delay compensation module 1205 may be referred to as reverse compensation. The combined control structure and delay compensation module 1205 has a combined control gain and one or more combined time constants associated therewith that are configured based on the gain and time constants associated with the phase shift for the control command and the phase shift for the time delay compensation. In some embodiments, when the total compensation is greater than 180°, then the sign of the gain used in the combined control structure and delay compensation module 1205 may be changed. As shown in FIG. 13, the adaptive WADC 150 with reverse compensation in accordance with the embodiments of FIG. 12 provides better low frequency oscillation damping than the original compensation approach or when no compensation is applied.

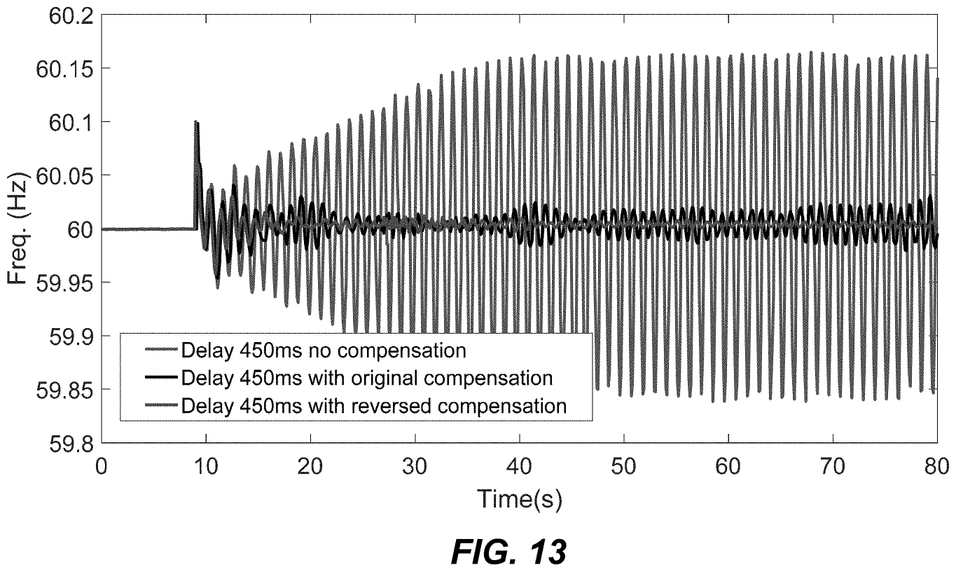

FIG. 14 is a graph that illustrates damping of low frequency inter-area oscillations with a non-adaptive WADC and with an adaptive WADC 150 in accordance with some embodiments of the inventive concept compared with no damping. As shown in FIG. 14, without the use of a WADC to provide damping for low frequency inter-area power system oscillations a power system may become relatively unstable. When a non-adaptive WADC is used to provide damping, the power system remains relatively unstable due to variations in the operating condition of the power system that are not accounted for by the power system planning model on which the WADC is based. The adaptive WADC, however, may adapt to current operating conditions of the power system by generating a transfer function model of the power system and using this model as a basis for updating the control parameters of the adaptive WADC. As shown in FIG. 14, the adaptive WADC may improve the stability of the power system.

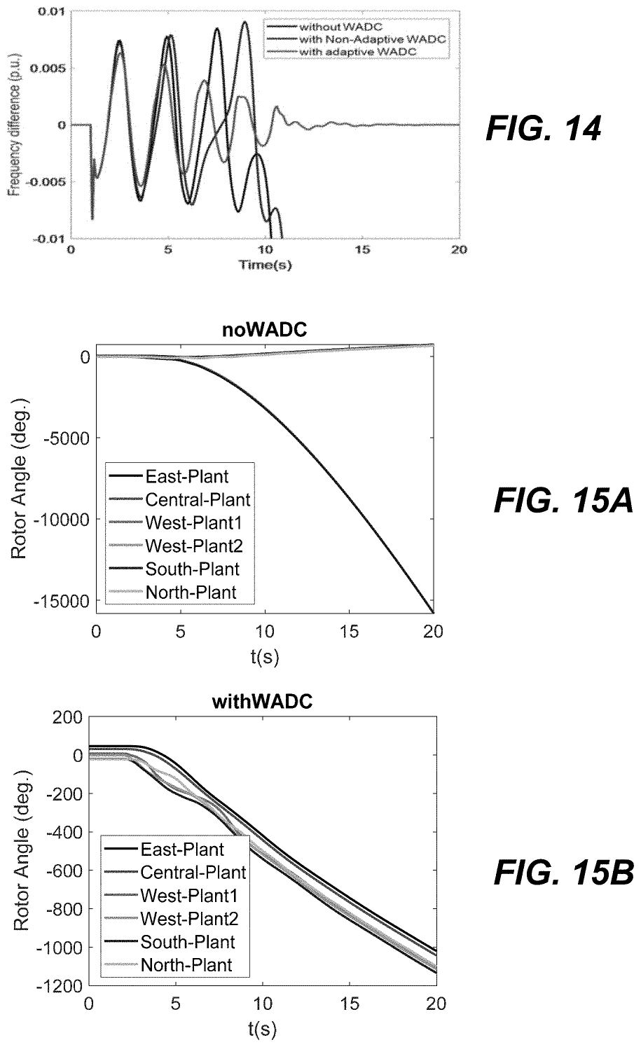

FIGS. 15A and 15B are graphs that illustrate separation of a power system without damping and preservation of the power system with damping provided by an adaptive WADC in accordance with some embodiments of the inventive concept. Referring to FIG. 15A, without the use of an adaptive WADC to provide damping of low frequency oscillation, the plans of a power system may separate due to instability. The adaptive WADC may inhibit power system separation as shown in FIG. 15 through improved stability provided by improved low frequency damping.

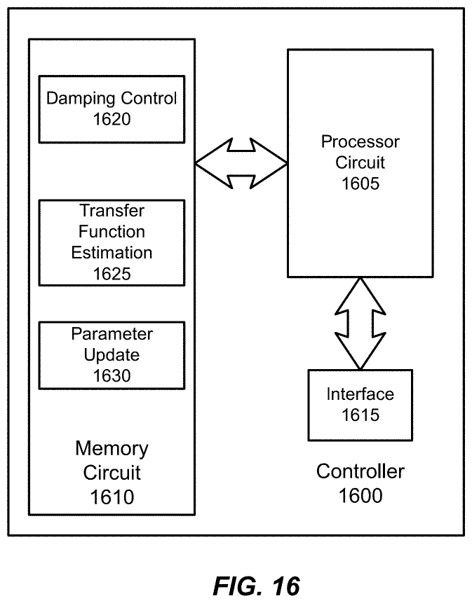

FIG. 16 is a simplified block diagram of a controller used in the adaptive WADC of FIG. 1 that is configured to perform operations according to one or more embodiments disclosed herein in accordance with some embodiments of the inventive concept. The controller 1600 comprises a processor circuit 1605, a memory circuit 1610, and an interface 1615. The interface may comprise a wireless and/or a wired interface, such as a wireless transceiver and a network adapter. The wireless transceiver and the network adapter may be configured to provide the controller 1600 with wireless and wireline communication functionality, respectively. In some embodiments, the interface 1615 may support a Joint Test Action Group (JTAG) port for communication. The processor circuit 1605 may comprise one or more data processing circuits, such as a general purpose and/or special purpose processor, e.g., microprocessor and/or digital signal processor. The processor circuit 1605 is configured to execute computer readable program code including a damping control module 1620, a transfer function estimation module 1625, and a parameter update module 1630 in the memory circuit 1610 to perform at least some of the operations described herein as being performed by the adaptive WADC 150. The damping control module 1620 may be configured to generate the control command V_{WADC}, which is used to provide low frequency damping in a power system in accordance with some embodiments of the inventive concept. The transfer function estimation module 1625 is configured to perform at least some of the operations described herein with respect to the transfer function model estimator 250, the flowcharts of FIGS. 5-7 and other figures describing the generation of the transfer function model of the power system in accordance with some embodiments of the inventive concept. The parameter update module 1630 is configured to perform at least some of the operations described herein with respect to the transfer function model estimator 250, the flowcharts of FIGS. 5-7 and other figures describing the updating of one or more control parameters of the adaptive WADC 150 in accordance with some embodiments of the inventive concept.

Some embodiments of the inventive concept may provide an adaptive WADC including methods and computer readable program products for operating the same in which a transfer function model of a power system may be generated based on measurements of power system operational parameter measurements. This transfer function model may then be used to update one or more control parameters of the WADC. This may allow the adaptive WADC to adapt to current power system operating conditions. A Hann signal may be injected into the power system as a stimulus for generating the transfer function model. The measurements of one or more operational parameters of the power system may be processed by associating them with the Hann signals with respect to time and then averaging them over time to reduce the impact of environmental and measurement noise. A buffer based approach can be used to reduce the impact of random time delays and to reduce the changes the frequency at which changes are made to one or more control parameters of the adaptive WADC. A reversed or combined compensation technique can be used to address random time delay in which phase shift for control and time delay are combined. If the total compensation is greater than 180 degrees, the sign of the gain may be changed instead. When deployed to reduce low frequency inter-area oscillations, the adaptive WADC may reduce the likelihood of power system separation.

### FURTHER DEFINITIONS AND EMBODIMENTS

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, LabVIEW, dynamic programming languages, such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive subject matter.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present disclosure of embodiments has been presented for purposes of illustration and description, but is not intended to be exhaustive or limited to the disclosure in the form disclosed. Many variations and modifications can be made to the embodiments without substantially departing from the principles of the present invention. All such variations and modifications are intended to be included herein within the scope of the present invention.

What is claimed is:

1. A method, comprising:
injecting a probe signal into a power system;
receiving a measurement of an operational parameter of the power system responsive to injecting the probe signal into the power system;
generating a transfer function model of the power system based on the measurement of the operational parameter of the power system and the probe signal; and
updating at least one control parameter of a Wide Area Damping Controller (WADC) communicatively coupled to the power system based on the transfer function model.

2. The method of claim 1, wherein the operational parameter of the power system is a frequency of a power system signal, a voltage magnitude of the power system signal, or a voltage angle of the power system signal.

3. The method of claim 1, wherein the probe signal has a magnitude whose value over time is represented by a Hann function.

4. The method of claim 1, wherein injecting the probe signal into the power system comprises:
injecting the probe signal at a voltage set point of a generator, at a voltage set point of a Flexible Alternating Current Transmission System (FACTS) device, or at an active power set point of a High Voltage Direct Current (HVDC) link.

5. The method of claim 1, wherein injecting the probe signal into the power system comprises:
repeating injection of the probe signal into the power system; and
wherein receiving the measurement of the operational parameter of the power system responsive to injecting the probe signal into the power system comprises:
receiving multiple measurements of the operational parameter of the power system responsive to repeating injection of the probe signal into the power system;
wherein the method further comprises:
averaging the multiple measurements of the operational parameter to generate an average measurement of the operational parameter.

6. The method of claim 5, wherein generating the transfer function model of the power system based on the measurement of the operational parameter of the power system and the probe signal comprises:
generating the transfer function model of the power system based on the average measurement of the operational parameter of the power system and the probe signal.

7. The method of claim 5, further comprising:
associating the multiple measurements of the operational parameter of the power system with the repeated injections of the probe signal, respectively, with respect to time.

8. The method of claim 1, further comprising:
storing the multiple measurements of the operational parameter of the power system in a buffer so as to be sorted by delay;
selecting ones of the multiple measurements of the operational parameter of the power system that are closest to a defined delay value; and
using the selected ones of the multiple measurements to generate a control command for damping low-frequency oscillations of the power system.

9. The method of claim 1, wherein updating the at least one control parameter of the WADC comprises:
updating a time constant, a control gain, or a filter transfer function used in the WADC.

10. The method of claim 1, wherein the WADC comprises a control structure module and a delay compensator module, each of the control structure module and the delay compensator module having at least one time constant and a control gain associated therewith; and
wherein updating the at least one control parameter of the WADC comprises:
updating the at least one time constant or the control gain in each of the control structure module and the delay compensator module.

11. The method of claim 1, wherein the WADC comprises a combined control structure module and delay compensator module having at least one combined time constant and a combined control gain associated therewith; and
wherein updating the at least one control parameter of the WADC comprises:
updating the at least one combined time constant or the combined control gain of the combined control structure module and delay compensator module.

12. A system, comprising:
a processor; and
a memory coupled to the processor and comprising computer readable program code embodied in the memory that is executable by the processor to perform operations comprising:
injecting a probe signal into a power system;
receiving a measurement of an operational parameter of the power system responsive to injecting the probe signal into the power system;
generating a transfer function model of the power system based on the measurement of the operational parameter of the power system and the probe signal; and
updating at least one control parameter of a Wide Area Damping Controller (WADC) communicatively coupled to the power system based on the transfer function model.

13. The system of claim 12, wherein the operational parameter of the power system is a frequency of a power system signal, a voltage magnitude of the power system signal, or a voltage angle of the power system signal.

14. The system of claim 12, wherein injecting the probe signal into the power system comprises:
repeating injection of the probe signal into the power system; and
wherein receiving the measurement of the operational parameter of the power system responsive to injecting the probe signal into the power system comprises:
receiving multiple measurements of the operational parameter of the power system responsive to repeating injection of the probe signal into the power system;
wherein the operations further comprise:
averaging the multiple measurements of the operational parameter to generate an average measurement of the operational parameter.

15. The system of claim 12, wherein updating the at least one control parameter of the WADC comprises:
updating a time constant, a control gain, or a filter transfer function used in the WADC.

16. The system of claim 12, wherein the WADC comprises a control structure module and a delay compensator module, each of the control structure module and the delay compensator module having at least one time constant and a control gain associated therewith; and
wherein updating the at least one control parameter of the WADC comprises:
updating the at least one time constant or the control gain in each of the control structure module and the delay compensator module.

17. The system of claim 12, wherein the WADC comprises a combined control structure module and delay compensator module having at least one combined time constant and a combined control gain associated therewith; and
wherein updating the at least one control parameter of the WADC comprises:
updating the at least one combined time constant or the combined control gain of the combined control structure module and delay compensator module.

18. A computer program product, comprising:
a non-transitory computer readable storage medium comprising computer readable program code embodied in the medium that is executable by a processor to perform operations comprising:
injecting a probe signal into a power system;
receiving a measurement of an operational parameter of the power system responsive to injecting the probe signal into the power system;
generating a transfer function model of the power system based on the measurement of the operational parameter of the power system and the probe signal; and
updating at least one control parameter of a Wide Area Damping Controller (WADC) communicatively coupled to the power system based on the transfer function model.

19. The system of claim 18, wherein the operational parameter of the power system is a frequency of a power system signal, a voltage magnitude of the power system signal, or a voltage angle of the power system signal.

20. The system of claim 18, wherein updating the at least one control parameter of the WADC comprises:
updating a time constant, a control gain, or a filter transfer function used in the WADC.
